(19) United States
(12) Patent Application Publication
(10) Pub. No.: US 2012/0000753 A1
(43) Pub. Date: Jan. 5, 2012

(54) QUAD BREAK MODULAR CIRCUIT BREAKER INTERRUPTER

(75) Inventor: Salaheddine Faik, Marion, IA (US)

(73) Assignee: Schneider Electric USA, Inc., Palatine, IL (US)

(21) Appl. No.: 12/827,689

(22) Filed: Jun. 30, 2010

(51) Int. Cl. H01H 19/02

(52) U.S. Cl. 200/11 J

(57) ABSTRACT

An interrupter includes at least four pairs of contacts. Each pair of contacts includes a stationary contact positioned to abut a corresponding moveable contact. The moveable contacts are coupled to a rotating member. The rotating member is coupled to a driving member via a biasing member. The driving member is rotated causing all four pairs of contacts to separate and open a circuit quickly.

### FIELD OF THE INVENTION

The present invention relates generally to circuit breakers and, more particularly, to modular circuit breakers with one modular interrupter per phase of electricity.

### BACKGROUND OF THE INVENTION

The internal design of a circuit breaker's interrupter defines its performance. Two characteristics used to measure a circuit breaker's performance include the peak current (Ip) and the energy integral (I²t). Designing a circuit breaker that minimizes these quantities is desirable to increase performance and lower the interruption time, which may increase the longevity of the circuit breaker among other benefits.

A first type of prior art circuit breaker includes one pair of contacts including a moveable contact attached to an arm that pivots about a fixed point and a fixed contact attached to a terminal of the circuit breaker. The contact pair remains pressed together until the circuit breaker trips, which causes the pair of contacts to physically separate, thereby breaking the flow of current therethrough. This first type of tripping mechanism is slow and not suitable for high-performance interruption.

A second type of prior art circuit breaker includes a rotating blade operating two pairs of contacts. A more complete description of the second type of prior art circuit breaker can be found in U.S. Pat. No. 4,910,485 to Mobleu et al. While the second type of prior art circuit breaker has a better interruption performance as compared to the first type with a single contact pair, a rotating blade operating two contact pairs is limited in its interruption performance. Specifically, to increase the interruption performance of such a circuit breaker, the rotating blade radius can be increased, which results in a sharp increase in the inertia of the moveable blade—as the inertia of the blade is proportional to the square of its radius. This sharp increase in inertia is disadvantageous as the necessary force to move the blade from a closed position to a tripped position is also sharply increased, which can result in a longer amount of time to interrupt the circuit.

Thus, a need exists for an improved apparatus. The present invention is directed to satisfying one or more of these needs and solving other problems.

### SUMMARY OF THE INVENTION

The present disclosure provides an interrupter for a circuit breaker having an increased interruption speed, i.e., the flow of electricity through the circuit breaker is interrupted in a shorter amount of time as compared to prior interrupters. The disclosed interrupter includes at least four pairs of contacts, a rotating member, and a driving member. The interrupter unit is configured to increase interruption speed with a linear increase of inertia by keeping a radius of the rotating member constant. The inclusion of 4, 6, 8 or more pairs of contacts according to the disclosed circuit breaker design increases the interruption speed, which is advantageous as a faster interruption speed may result in a more robust and longer lasting circuit breaker.

The foregoing and additional aspects and embodiments of the present invention will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the invention will become apparent upon reading the following detailed description and upon reference to the drawings.

FIG. 1 is a functional block diagram of a circuit breaker having an interruption unit in a circuit according to some aspects of the present disclosure;

FIG. 2A is a plan view of the interruption unit of FIG. 1 in a closed position;

FIG. 2B is a plan view of the interruption unit of FIG. 1 in an intermediate position; and

FIG. 2C is a plan view of the interruption unit of FIG. 1 in a tripped position.

### DETAILED DESCRIPTION OF THE ILLUSTRATED EMBODIMENTS

Although the invention will be described in connection with certain aspects and/or embodiments, it will be understood that the invention is not limited to those particular aspects and/or embodiments. On the contrary, the invention is intended to cover all alternatives, modifications, and equivalent arrangements as may be included within the spirit and scope of the invention as defined by the appended claims.

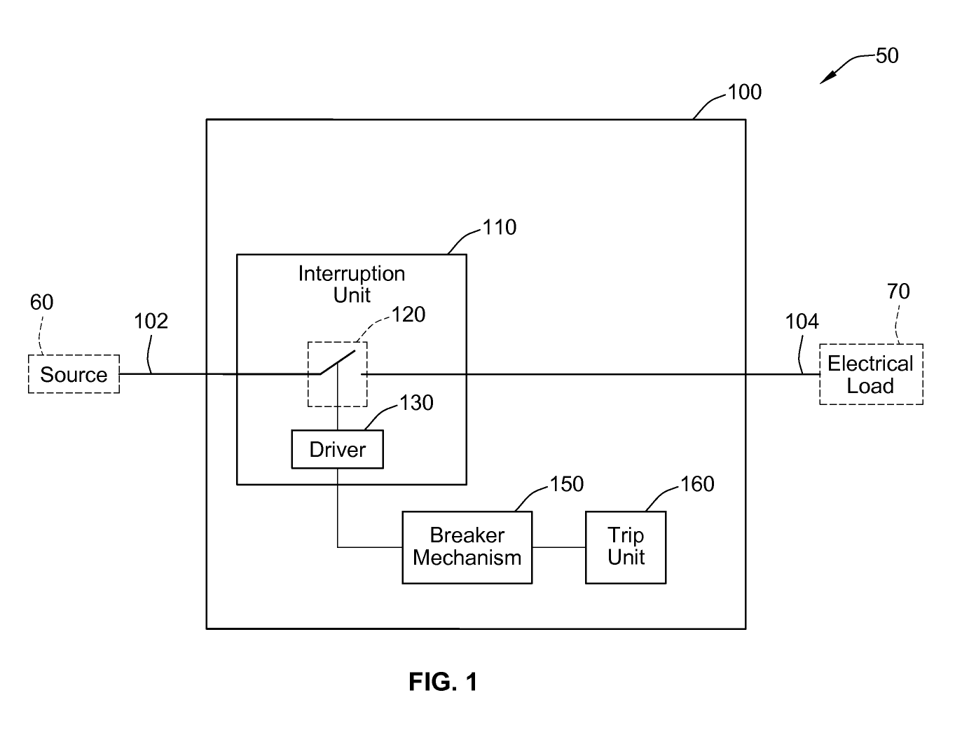

Referring to FIG. 1, a functional block diagram of a circuit 50 including a circuit breaker 100 is shown. The circuit breaker 100 includes an interruption unit 110, a breaker mechanism 150, and a trip unit 160. The circuit breaker 100 is configured to handle between 0 and 760 volts. Other voltages are contemplated, such as, for example, between 0 and 1000 volts. The interruption unit 110 includes a rotary arm assembly 120 and a driving member or driver 130. Electricity can be conducted along the circuit 50 and through the circuit breaker 100 via a line terminal 102, through the interruption unit 110, and exiting a load terminal 104. The line terminal 102 can be electrically coupled to an electrical source 60, such as, for example, a power utility, an electrical generator, or the like. The load terminal 104 can be electrically coupled to an electrical load 70, such as, for example, a light fixture, a motor, an appliance, etc.

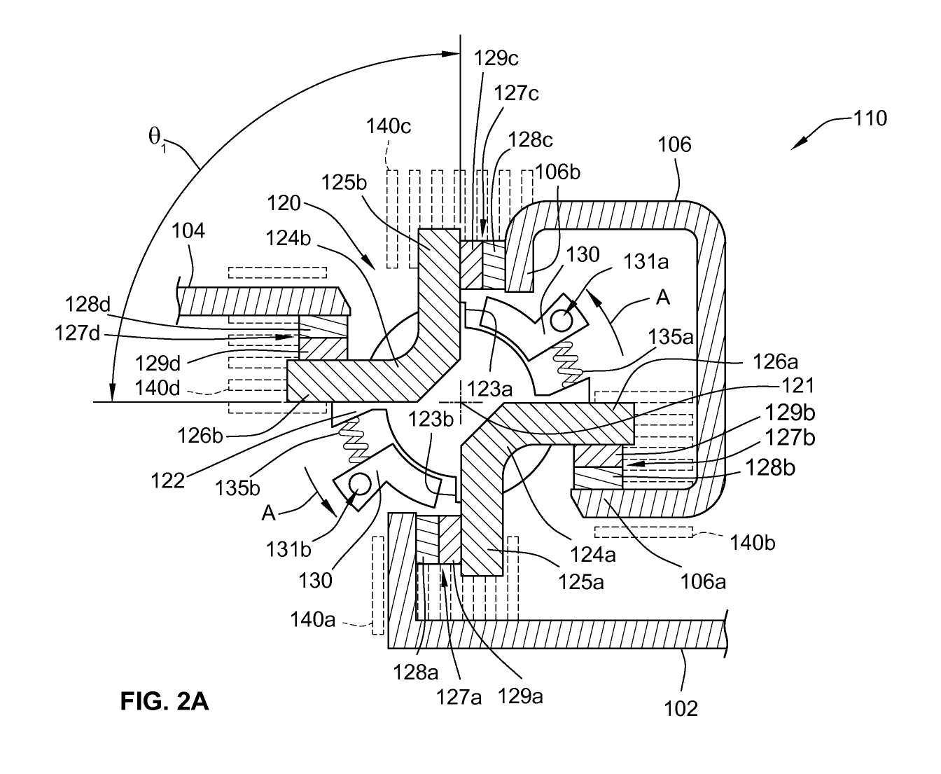

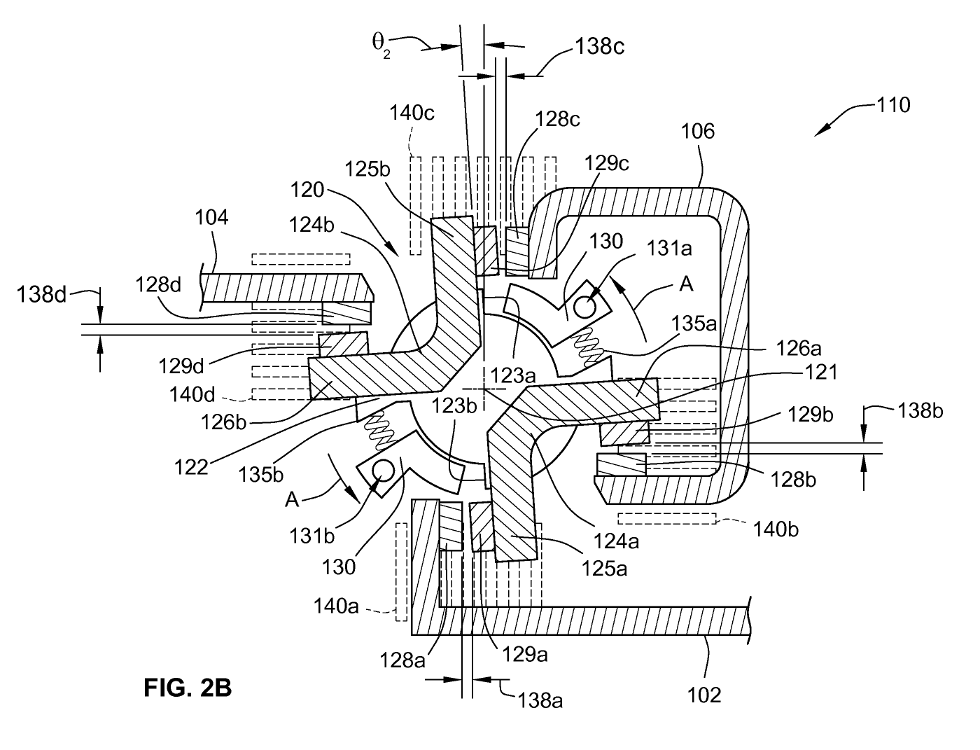

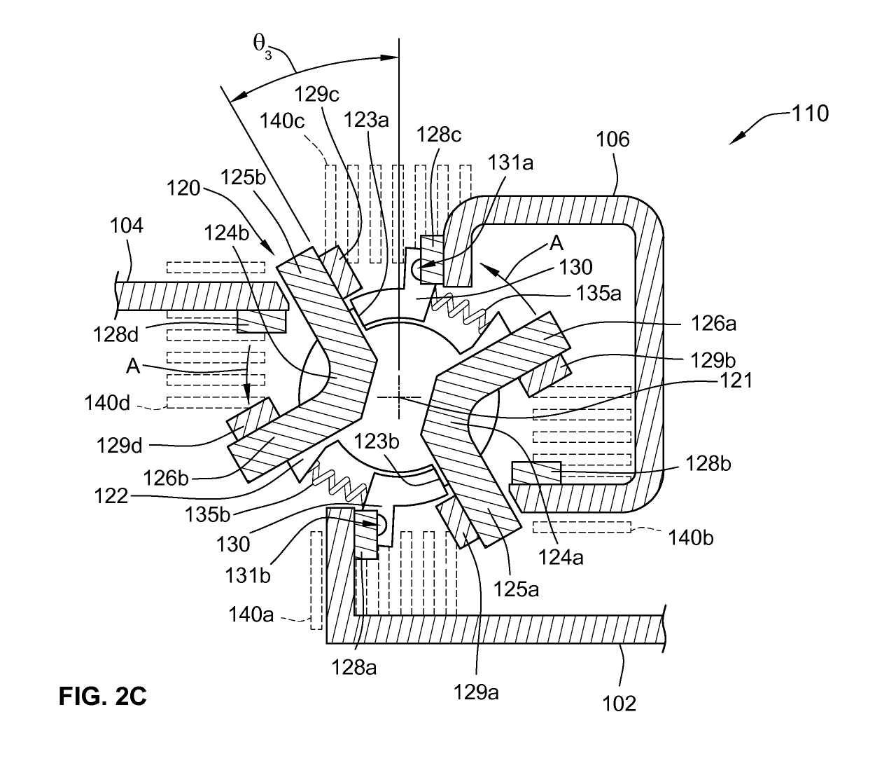

The trip unit 160 is configured to monitor the circuit 50 for undesired fault conditions and to cause a chain reaction of mechanical actions, which interrupts the circuit 50 in response to detecting a fault condition. Fault conditions may include, for example, arc faults, overloads, ground faults, and short-circuits. In response to detecting a fault condition, the trip unit 160 releases the breaker mechanism 150, which frees the breaker mechanism 150 to act on the interruption unit 110. The breaker mechanism 150 can include, for example, a bimetal mechanism, a magnetic armature mechanism, an electronic or electro-magnetic mechanism, or a combination thereof. As explained herein in further detail, the breaker mechanism 150 is configured to switch the driving member 130 of the interruption unit 110 from a closed position to a tripped position, which in the process of switching causes the rotary arm assembly 120 to rotate. The rotation of the rotary arm assembly 120 separates four pairs of contacts 127a-d (FIG. 2A-C), which interrupts the circuit 50.

Referring to FIG. 2A, the interruption unit 110 is shown in a closed position. In the closed position, current is free to flow in the circuit 50 through the interruption unit 110 to the electrical load 70, that is, the circuit 50 is closed. The interruption unit 110 includes the rotary arm assembly 120, the driving member 130, and the four pairs of contacts 127a-d.

Each of the first through fourth pairs of contacts 127a-d includes a stationary contact 128a-d and a corresponding moveable contact 129a-d. Specifically, the first stationary contact 128a and the first moveable contact 129a form the first pair of contacts 127a. Similarly, the second stationary contact 128b and the second moveable contact 129b form the second pair of contacts 127b, the third stationary contact 128c and the third moveable contact 129c form the third pair of contacts 127c, and the fourth stationary contact 128d and the fourth moveable contact 129d form the fourth pair of contacts 127d.

The first stationary contact 128a is coupled to or integral with the line terminal 102 such that the first stationary contact 128a is configured to be electrically connectable to the first moveable contact 129a. The second stationary contact 128b is coupled to, or integral with, a first end 106a of an intermediate terminal 106 such that the second stationary contact 128b is configured to be electrically connectable to the second moveable contact 129b. The third stationary contact 128c is coupled to or integral with a second end 106b of the intermediate terminal 106 such that the third stationary contact 128c is configured to be electrically connectable to the third moveable contact 129c. The fourth stationary contact 128d is coupled to or integral with the load terminal 104 such that the fourth stationary contact 128d is configured to be electrically connectable to the fourth moveable contact 129d. The stationary contacts 128a-d if desired can be made of the same conductive material as the terminals 102, 104, 106. The stationary contacts 128a-d are generally fixed relative to an outer housing (not shown) of the interruption unit 110 as known in the art.

The rotary arm assembly 120 includes a rotating member 122 and two electrically conducting arms 124a,b. The rotating member 122 can be of any shape or form that rotates about an axis. As shown in FIG. 2A, the rotating member 122 is in a closed position where each of the moveable contacts 129a-d substantially touches a respective one of the stationary contacts 128a-d. The rotating member 122 is illustrated as having a generally barrel shape that rotates about its central axis 121. The rotating member 122 can be made of any electrically insulating material, such as, for example, plastic, rubber, non-conducting metals, etc. The rotating member 122 includes two lips or surfaces 123a,b positioned to be engaged by the driving member 130. As illustrated in FIG. 2C, the driving member 130 is configured to engage one or more of the lips 123a,b to cause the rotary arm assembly 120 to rotate in the direction of arrow A. The lips 123a,b are formed in the rotating member 122 such that movement of the driving member 130 causes rotation of the rotating member 122 about its central axis 121.

Referring generally to FIG. 2A-2C, the two electrically conducting arms 124a,b are rigidly coupled to the rotating member 122 such that the arms 124a,b rotate in unison with the rotating member 122. The arms 124a,b can be made of any electrically conducting material, such as, for example, copper, gold, etc. Each of the arms 124a,b has a generally “L” shape defined by angle θ₁ (shown in FIG. 2A). θ₁ is about 90 degrees such that the four pairs of contacts 127a-d are positioned about 90 degrees apart.

The first arm 124a has a first end 125a and a second end 126a approximately the same distance from a bend in the first arm 124a. Similarly, the second arm 124b has a first end 125b and a second end 126b approximately the same distance from a bend in the second arm 124b. The first moveable contact 129a is coupled to or integral with the first end 125a of the first arm 124a and the second moveable contact 129b is coupled to or integral with the second end 126a of the first arm 124a. Similarly, the third moveable contact 129c is coupled to or integral with the first end 125b of the second arm 124b and the fourth moveable contact 129d is coupled to or integral with the second end 126b of the second arm 124b.

The driving member 130 is coupled to the rotating member 122 via two biasing members 135a,b, such as, for example, two springs. In FIG. 2A where the driving member 130 is locked in a closed position, the biasing members 135a,b are compressed such that the biasing members 135a,b bias and/or force the moveable contacts 129a-d to abut the corresponding stationary contacts 128a-d. The driving member 130 includes a first attachment point 131a and a second attachment point 131b. The breaker mechanism 150 is coupled to the driving member 130 via the attachment points 131a,b. For example, pins (not shown) positioned through the attachment points 131a,b can be mechanically coupled to the breaker mechanism 150.

During normal and/or some fault conditions, current flows through the circuit 50 from the source 60 to the load 70. The line terminal 102, the intermediate terminal 106, the load terminal 104, the two electrically conducting arms 124a,b, the stationary contacts 128a-d, and the moveable contacts 129a-d are configured such that electricity can be conducted through the line terminal 102, to the first stationary contact 128a, to the first moveable contact 129a, through the first arm 124a, to the second moveable contact 129b, to the second stationary contact 128b, through the intermediate terminal 106, to the third stationary contact 128c, to the third moveable contact 129c, through the second arm 124b, to the fourth moveable contact 129d, to the fourth stationary contact 128d, and through the load terminal 104 when the driving member 130 is in the closed position.

Current flowing through the pairs of contacts 127a-d can create a repulsion force between the respective pairs of contacts 127a-d that tends to force the respective contact pairs apart. Under rated current, the repulsion force is not strong enough to separate the respective pairs of contacts 127a-d and cause current to stop flowing across the pairs of contacts 127a-d because the biasing members 135a,b bias the respective pairs of contacts 127a-d to be pressed together. The present disclosure exploits the natural contact repulsion to assist in rapidly interrupting the current under short circuit conditions as is known in the art. As shown in FIG. 2B, a repulsion force, under short circuit conditions, acting on the interruption unit 110 can cause the four pairs of contacts 127a-d to separate a distance 138a-d. The repulsion forces cause the rotary arm assembly 120 to rotate in the direction of arrow A by an angle θ₂ (shown in FIG. 2B). It is contemplated that θ₂ can be between about zero and fifteen degrees, which results in the corresponding airgaps 138a-d between each of the four contact pairs 127a-d.

As shown in FIG. 2B, the interrupter unit 110 is in an intermediate position, which means that the contact pairs 127a-d are not completely closed together and in physical contact with one another such as shown in FIG. 2A. Rather, in FIG. 2B, the contact pairs 127a-d are separated by a small distance due to the magnetic repulsion forces described above without interrupting the flow of current across the contact pairs 127a-d. The driving member 130 is maintained in the closed position as in FIG. 2A; however, as the rotary arm assembly 120 rotates in the direction of arrow A due to the repulsive forces, the rotation causes the biasing members 135a,b to further compress.

An equal repulsion force can be generated between each of the pairs of contacts 127a-d causing each of the pairs of contacts 127a-d to separate an equal distance 138a-d. As the pairs of contacts 127a-d separate, an arc voltage develops between each of the pairs of contacts 127a-d and increases with the separation distance. When a sum of the arc voltages between the pairs of contacts 127a-d is greater than an instantaneous voltage of the circuit 50, the arc is extinguished and the current flow is interrupted. The four pairs of contacts 127a-d develop a cumulative arc voltage four times greater than a circuit breaker having only one pair of contacts separated by a distance equal to the gaps between the four pairs of contacts 127a-d. Similarly, the four pairs of contacts 127a-d develop a cumulative arc voltage two times greater than a circuit breaker having two pairs of contacts separated by a distance equal to the gaps between the four pairs of contacts 127a-d. Thus, the interruption unit 110 of the present disclosure can interrupt the circuit 50 about four times faster than an interruption unit having one pair of contacts and about two times faster than an interruption unit having two pairs of contacts. The faster interruption of a circuit is desirable as it reduces the peak current (Ip) and energy integral (I²t) characteristics of the circuit breaker 100. This reduction of peak current (Ip) and energy integral (I²t) characteristics and can extend the life of the circuit breaker 100 by reducing the time the internal components of the circuit breaker 100, such as the contacts, are exposed to fault conditions.

Referring to FIGS. 2A and 2C, the driving member 130 is positioned about the rotating member 122 such that the driving member 130 is configured to rotate in the direction of the arrow A about the central axis 121. As shown, the driving member 130 is configured to rotate about the central axis 121 of the rotating member 122 between its closed position (FIG. 2A) and its tripped position (FIG. 2C). In FIG. 2A, the interruption unit 110 is in the closed position where the driving member 130 is locked in place by the breaker mechanism 150 (FIG. 1) such that the driving member 130 is not free to rotate. During non-short circuit conditions of the circuit breaker 100, current flows through the contact pairs 127a-d until the breaker mechanism 150 is released. However, in response to the trip unit 160 (FIG. 1) releasing the breaker mechanism 150, the breaker mechanism 150 is configured to urge the driving member 130 from its closed position (FIG. 2A) to its tripped position (FIG. 2C). Switching or rotating the driving member 130 from the closed position (FIG. 2A) to the tripped position (FIG. 2C) in the direction of arrow A causes the driving member 130 to engage or act upon the lips 123a,b of the rotating member 122. The engagement of the driving member 130 with the lips 123a,b of the rotating member 122 causes the rotary arm assembly 120 to rotate in the direction of arrow A about the central axis 121 of the rotating member 122.

As shown in FIG. 2C, the rotary arm assembly 120 is configured to rotate in the direction of arrow A by an angle θ₃. It is contemplated that θ₃ can be between about 15 and 30 degrees, but should in any implementation be sufficient to cause no electrical current to flow across the airgap between stationary and moveable contacts 128a-d, 129a-d. Such rotation of the rotary arm assembly 120 through θ₃ causes each of the moveable contacts 129a-d to move away from the corresponding stationary contacts 128a-d, thereby opening the circuit 50. In the tripped position (FIG. 2C), the driving member 130 is locked in place and the biasing members 135a,b are substantially uncompressed. An operator can reset the interruption unit 110 back to the closed position by, for example, mechanically rotating the driving member 130 back to its closed position via a handle (not shown) attached to the breaker mechanism 150.

Referring generally to FIGS. 2A-2C, arc chutes 140a-d can optionally be positioned adjacent each of the pairs of contacts 127a-d within the housing (not shown) of the circuit breaker 100.

While the stationary contacts 128a-d are shown as being separate elements coupled to the respective terminals 102, 104, 106, it is contemplated that the stationary contacts 128a-d and the respective terminals 102, 104, 106 are formed from a single piece of material. For example, the line terminal 102 and the first stationary contact 128a can be formed from the same piece of material. For another example, the intermediate terminal 106 and the second and the third stationary contacts 128b,c can be formed from a single piece of material. For a third example, the load terminal 104 and the fourth stationary contact 128d can be formed from the same piece of material.

While the rotating member 122 is shown as having a generally barrel shape, it is contemplated that the rotating member 122 can have other shapes, such as, for example, a square shape, a rectangular shape, a generally “X” shape or cross shape, a generally “T” shape, etc.

While the rotating member 122 is shown as having two lips 123a,b, it is contemplated that the rotating member 122 can include only one lip 123a or 123b, or more than two lips.

While the driving member 130 is illustrated as having a first attachment point 131a and a second attachment point 131b, it is contemplated that the driving member 130 includes only one attachment point 131a or 131b, or more than two attachment points.

While the interruption unit 110 is illustrated as having a first biasing member 135a and a second biasing member 135b, it is contemplated that the interruption unit 110 includes only one biasing member 135a or 135b, or more than two biasing members.

While θ₁ is illustrated as being about 90 degrees, other angles for θ₁ are contemplated. For example, θ₁ can be 30 degrees, 45 degrees, 60 degrees, 75 degrees, 105 degrees, 135 degrees, 150 degrees, 180 degrees, etc.

For the examples where θ₁ is less than 90 degrees, such as, for example, 45 degrees, one or more additional arms can be coupled to the rotating member 122. The additional arm(s) can include moveable contacts configured to abut additional stationary contacts coupled with additional intermediate terminals. Such additional elements can be arranged such that the interruption unit 110 includes, for example, 6, 8, or more pairs of contacts.

For the examples where θ₁ is greater than 90 degrees, the two arms can be coupled to the rotating member 122 such that the arms are electrically insulated from each other. For example, the arms can be positioned in different planes along the axis of rotation of the rotating member 122. For another example, one of the arms can be bent and/or formed around the other arm.

While the driving member 130 is illustrated as rotating about the central axis 121 of the rotating member 122, it is contemplated that the driving member 130 can rotate about a different axis, such as, for example, a pivot point elsewhere in the circuit breaker 100. It is also contemplated that instead of rotating, the driving member 130 can be a solenoid or other electro-mechanical mechanism configured to act on the rotary arm assembly 120.

It is contemplated that the terminals 102, 104, and 106 can be made with one or more blow-off loops, which can create additional and/or larger repulsive forces between the pairs of contacts 127a-d in the interruption unit 110.

While the interruption unit 110 illustrated is for a single pole circuit breaker, it is contemplated that the interruption unit 110 is a building block that can be coupled to one or more additional interruption units that are the same as, or similar to, the interruption unit 110, to form a multi-pole circuit breaker. For example, each of the interruption units includes four pairs of contacts, a respective rotating member, and a respective driving member coupled to the respective rotating members via respective biasing members.

Words of degree, such as “about”, “substantially”, and the like are used herein in the sense of “at, or nearly at, when given the manufacturing, design, and material tolerances inherent in the stated circumstances” and are used to prevent the unscrupulous infringer from unfairly taking advantage of the invention disclosure where exact or absolute figures are stated as an aid to understanding the invention.

While particular aspects, embodiments, and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. An interrupter unit for a circuit breaker, comprising:
a rotary arm assembly including a rotating member and first and second arms, each of the arms being rigidly coupled to the rotating member such that the arms rotate in unison with the rotating member, each of the arms having a first end and a second end, the first end of the first arm including a first moveable contact, the second end of the first arm including a second moveable contact, the first end of the second arm including a third moveable contact, and the second end of the second arm including a fourth moveable contact;
a line terminal including a first stationary contact that is configured to be electrically connected with the first moveable contact;
an intermediate terminal including a second stationary contact configured to be electrically connected with the second moveable contact and a third stationary contact configured to be electrically connected with the third moveable contact;
a load terminal including a fourth stationary contact configured to be electrically connected with the fourth moveable contact; and
a driving member having a closed position and a tripped position, the driving member being coupled to the rotary arm assembly via a biasing member, the biasing member biasing the rotary arm assembly such that the moveable contacts are positioned to electrically couple with the respective stationary contacts in response to the driving member being in the closed position, the driving member being configured to rotate the rotary arm assembly to separate the moveable contacts from the respective stationary contacts such that the moveable contacts are electrically insulated from the stationary contacts in response to the driving member switching from the closed position to the tripped position.

2. The interrupter unit of claim 1, wherein the rotating member includes at least one lip, the driving member being configured to engage the at least one lip of the rotating member to rotate the rotary arm assembly.

3. The interrupter unit of claim 1, wherein the biasing member is a spring, the biasing member being compressed to bias the moveable contacts to abut the respective stationary contacts such that current is conducted through the interrupter unit without arcing.

4. The interrupter unit of claim 1, wherein the rotary arm assembly and the driving member both rotate about a common axis.

5. The interrupter unit of claim 1, wherein each of the arms have a generally “L” shape and are positioned such that the stationary contacts are substantially 90 degrees apart.

6. The interrupter unit of claim 1, wherein each of the arms are generally straight and are positioned such that the stationary contacts are substantially 90 degrees apart.

7. The interrupter unit of claim 1, wherein the rotating member includes an insulating material and the arms include a conducting material.

8. The interrupter unit of claim 1, wherein the moveable contacts are integral with the arms such that the moveable contacts and the arms are formed from a single piece of material.

9. The interrupter unit of claim 1, wherein the driving member is coupled to a breaker mechanism that is configured to switch the driving member from the closed position to the tripped position.

10. The interrupter unit of claim 9, wherein the breaker mechanism is coupled to a trip unit that is configured to release the breaker mechanism such that the breaker mechanism switches the driving member from the closed position to the tripped position.

11. An interrupter unit for a circuit breaker, comprising:
first, second, third, and fourth moveable contacts operatively coupled to a rotating member;
a first stationary contact that is positioned to abut the first moveable contact;
a second stationary contact positioned to abut the second moveable contact;
a third stationary contact positioned to abut the third moveable contact;
a fourth stationary contact positioned to abut the fourth moveable contact; and
a driving member having a closed position and a tripped position, the driving member being coupled to the rotating member via at least one biasing member, the at least one biasing member biasing the rotating member such that the moveable contacts are positioned to electrically couple with the respective stationary contacts in response to the driving member being in the closed position, the driving member being configured to rotate the rotating member to separate the moveable contacts from the respective stationary contacts such that the moveable contacts are electrically insulated from the respective stationary contacts in response to the driving member switching from the closed position to the tripped position.

12. The interrupter unit of claim 11, wherein the first, second, third, and fourth moveable contacts are operatively coupled to the rotating member via first and second electrically conducting arms.

13. The interrupter unit of claim 12, further comprising a line terminal, an intermediate terminal, and a load terminal.

14. The interrupter unit of claim 13, wherein the line terminal, the intermediate terminal, the load terminal, the first and second electrically conducting arms, the stationary contacts, and the moveable contacts are configured such that electricity can be conducted through the line terminal, to the first stationary contact, to the first moveable contact, through the first electrically conducting arm, to the second moveable contact, to the second stationary contact, through the intermediate terminal, to the third stationary contact, to the third moveable contact, through the second electrically conducting arm, to the fourth moveable contact, to the fourth stationary contact, and through the load terminal.

15. The interrupter unit of claim 11, wherein the at least one biasing member is compressed when the driving member is in the closed position.

16. The interrupter unit of claim 15, wherein the rotating member is configured to rotate between about zero and fifteen degrees from a closed position while the driving member is in the closed positioned, the rotation of the rotating member causing the at least one biasing member to further compress.

17. The interrupter unit of claim 11, wherein the rotating member is configured to rotate up to about thirty degrees from a closed position in response to the driving member switching from the closed position to the tripped position.

18. A circuit breaker, comprising:
a first interrupter unit, the first interrupter unit including:
four pairs of contacts, each pair including a stationary contact positioned to abut a corresponding moveable contact;
a rotating member, each of the moveable contacts being coupled to the rotating member; and
a driving member coupled to the rotating member via a biasing member, the driving member being rotated by a breaker mechanism to cause the moveable contacts to rotate together away from the corresponding stationary contacts about the rotating member.

19. The circuit breaker of claim 18, wherein the rotating member includes two arms, the rotating member being rotatable up to about thirty degrees.

20. The circuit breaker of claim 18, wherein the circuit breaker is a three pole circuit breaker, the circuit breaker further comprising a second interrupter unit and a third interrupter unit, the first, second, and third interrupter units being mechanically coupled together.
